(19) United States
(12) Patent Application Publication
(10) Pub. No.: US 2013/0063234 A1
(43) Pub. Date: Mar. 14, 2013

(54) HIGH POWER INDUCTOR AND IGNITION TRANSFORMER USING PLANAR MAGNETICS

(71) Applicants: Girish R. Kamath, Lebanon, NH (US); Norman LeBlanc, Claremont, NH (US); Wayne Chin, Etna, NH (US); Paul Tillman, Ascutney, VT (US)

(72) Inventors: Girish R. Kamath, Lebanon, NH (US); Norman LeBlanc, Claremont, NH (US); Wayne Chin, Etna, NH (US); Paul Tillman, Ascutney, VT (US)

(73) Assignee: HYPERTHERM, INC., Hanover, NH (US)

(21) Appl. No.: 13/543,236

(22) Filed: Jul. 6, 2012

Related U.S. Application Data
(60) Provisional application No. 61/505,476, filed on Jul. 7, 2011.

(51) Int. Cl. H01F 27/08; H01F 41/04

(52) U.S. Cl. 336/57; 29/602.1; 29/606; 336/60

(57) ABSTRACT

Described are methods and systems for using a planar inductor that includes a magnetically conductive core, a first planar coil and a second planar coil. The first and second planar coils are attached to a first bridge, located about the core, and are composed of a conductive material. The first and second planar coils have at least one thermally conductive surface exposed to cooling fluid. The first planar coil, the first bridge and the second planar coil are formed from a first unitary section of conductive material. The second planar coil is positioned relative to the first planar coil in a spaced relationship, which is defined by a thickness of the first bridge. An upper surface of the first planar coil is oriented toward a lower surface of the second planar coil to define a first cooling channel between the first planar coil and the second planar coil.

### RELATED APPLICATIONS

This application claims the benefit of and priority to U.S. Provisional Application No. 61/505,476, filed Jul. 7, 2011, the entirety of which is hereby incorporated herein by reference.

### FIELD OF THE INVENTION

This invention relates generally to inductors and ignition transformers using planar magnetics.

### BACKGROUND OF THE INVENTION

Magnetic components such as inductors and transformers are used in power supply designs for various devices, including plasma cutting power supplies. High voltage ignition transformers form an integral part of the high voltage high frequency (“HVHF”) circuits used in plasma cutting systems. Traditionally, these types of transformers are fabricated using custom made plastic bobbins that ensure appropriate inter-winding spacing and clearance to meet regulatory and functional specifications. The windings are typically wound manually and need to be done precisely in order to meet the self inductance and coupling factor requirements of the application.

Custom made plastic bobbins have a significant impact on the size and cost of a transformer. Furthermore, the windings can often have fractional turns and imprecise winding methods results in unit to unit start reliability variance. Further, the use of custom made bobbins can make it difficult to have manufacturer redundancy, resulting in supply chain vulnerability.

Inductors and transformers can account for a significant portion of the power supply cost. Inductors and transformers can also account for a majority of a power supply's weight. The effort to reduce the cost of these components can be driven by the expectation of increase in the price of materials, such as copper and steel, due to the increase in global demand. For example, the price of copper has increased by more than 40% between 2010 and 2011.

Planar technology has been used to improve on the current methods by reducing size and cost. One aspect of planar technology replaces copper wires with copper-clad printed circuit boards (“PCBs”). Using PCBs in lieu of copper wires can reduce the amount of copper used. In some examples, there is a reduction of more than 50% in the amount of copper used. However, using PCBs in lieu of copper wires still results in other issues, such as overheating and cost at high currents (e.g., 80 amps or higher).

### SUMMARY OF THE INVENTION

The invention uses planar coils composed of conductive materials to replace windings of wire. The planar coils are scalable and can be stacked to form a planar inductor. Two or more planar inductors can be used to form a transformer.

The invention, in one aspect, features a planar inductor that includes a magnetically conductive core, a first planar coil and a second planar coil. The first planar coil is attached to a first bridge and is located about the core. The first planar coil is made out of a conductive material and has at least one thermally conductive surface exposed to cooling fluid. The second planar coil is also attached to the first bridge and is also located about the core. Like the first planar coil, the second planar coil is made out of a conductive material and has at least one thermally conductive surface exposed to cooling fluid. The first planar coil, the first bridge and the second planar coil are formed from a first unitary section of conductive material. The second planar coil is positioned relative to the first planar coil in a spaced relationship. The spaced relationship is defined by a thickness of the first bridge. An upper surface of the first planar coil is oriented toward a lower surface of the second planar coil to define a first cooling channel between the first planar coil and the second planar coil.

Another aspect of the invention includes a method of manufacturing a planar inductor that includes cutting a section of thermally conductive material into a pattern to create a first planar coil, a second planar coil and a bridge that is disposed between the first and second planar coils. The method also bends the section of thermally conductive material at the bridge so that the second planar coil is positioned opposite and at least substantially in parallel to the first planar coil. At least two connection points a created during manufacturing for a combination of the first planar coil, the bridge and the second planar coil.

Another aspect of the invention includes a method of manufacturing an ignition transformer that includes selecting two or more planar inductors that are created by cutting a section of thermally conductive material into a pattern to create a first planar coil, a second planar coil and a bridge disposed between the first and second planar coils, bending the section of thermally conductive material at the bridge such that the second planar coil is positioned opposite and at least substantially in parallel to the first planar coil, and creating at least two connection points for a combination of the first planar coil, the bridge and the second planar coil. The method further includes coupling the two or more planar inductors by placing the two or more planar inductors in a close proximity so that there is a fixed gap between the two or more planar inductors.

Another aspect of the invention includes a method of using planar coils to form a planar inductor. The method includes utilizing a magnetically conductive core, utilizing a first planar coil, which is attached to a first bridge, and is located about the core, and utilizing a second planar coil, which is also attached to the first bridge, and is also located about the core. The first planar coil and the second planar coil are made up of a conductive material and have at least one thermally conductive surface exposed to cooling fluid. The first planar coil, the bridge and the second planar coil are formed from a first unitary section of conductive material, and the second planar coil is positioned relative to the first planar coil in a spaced relationship defined by a thickness of a bent portion of the first bridge. An upper surface of the first planar coil is oriented toward a lower surface of the second planar coil to define a first cooling channel between first planar coil and the second planar coil.

Another aspect of the invention includes a combination heat exchanger inductor that has a magnetically conductive core, a substantially rigid, first planar coil located about the core, a substantially rigid, second planar coil located about the core, and a substantially rigid bridge contiguous with said first and second planar coils. The first planar coil is made of conductive material and has a first exposed thermally conductive surface. The second planar coil is made of conductive material and has a second thermally conductive surface. The bridge is made of said conductive material and is oriented at least substantially orthogonal to the first and second planar coils so that the bridge can provide a spaced relationship and define a cooling channel, while orienting the first and second thermally conductive surfaces opposite each other with the cooling channel.

Another aspect of the invention includes a method of manufacturing an inductor that includes providing a magnetically conductive core, etching a conductive material to form a substantially rigid first planar coil that has first exposed thermally conductive surface and a second planar coil that has a second thermally conductive surface. The method also includes manipulating the conductive material to form a substantially rigid bridge contiguous with the first and second planar coils such that the bridge is oriented at least substantially orthogonal to the first and second planar coils in order to provide a spaced relationship and define a cooling channel, and to orient said first and second thermally conductive surfaces opposite each other with the cooling channel therebetween.

Each of the aspects above can further employ one or more of the following advantages.

In some embodiments, a third planar coil, attached to a second bridge is located about the core and is composed of the conductive material. The third planar coil can have at least one thermally conductive surface exposed to cooling fluid. A fourth planar coil, which attached to the second bridge and is located about the core, is composed of conductive material and has at least one thermally conductive surface exposed to cooling fluid. The third planar coil, the second bridge and the fourth planar coil are formed from a second unitary section of conductive material. The third planar coil is positioned relative to the second planar coil in a spaced relationship equal to the thickness of a bent portion of the first bridge or the thickness of a bent portion of the second bridge such that an upper surface of the second coil is oriented toward a lower surface of the third coil to define a second cooling channel between second planar coil and the third planar coil. The fourth planar coil is positioned relative to the third planar coil in a spaced relationship defined by a thickness of a bent portion of the second bridge such that an upper surface of the third coil is oriented toward a lower surface of the fourth coil to define a third cooling channel between third planar coil and the fourth planar coil. The magnetically conductive core can be an E-type core.

In some embodiments, the number of cooling channels can be 2n−1, where n is the number of pairs of planar coils. Fluid cooling can be done using a fan that is oriented to direct an air flow to cool the planar inductor through the first cooling channel, below the first planar coil and above the second planar coil.

In some embodiments, a first pair of planar coils can be positioned in a spaced relationship relative to a second part of planar coils such that the spaced relationship is equal to a thickness of a bent portion of the first pair bridge or a thickness of a bent portion of the second pair bridge. In some embodiments, the thickness of the bent portion of the first bridge and the thickness of the bent portion of the second bridge is the same. Te first unitary section of conductive material and the second unitary section of conductive material can be identical. The conductive material can be cooper or aluminum.

In some embodiments, the second planar coil and the third planar coil are soldered together so that the first planar coil, the second planar coil, the third planar coil and the fourth planar coil are connected through the first bridge, a solder joint, and the second bridge. A first connector and a second connector can be added to a planar inductor in order to connect the planar inductor to a voltage source or a load. In some embodiments, the planar coils can be stacked to achieve a desired inductance value.

In some embodiments, an ignition transformer can include a first and a second planar inductor. The first and the second planar inductor can be separated by a fixed gap to provide a predetermined inductance value for the ignition transformer. The fixed gap can be maintained using standoffs or spacers of a required height bobbin.

In some embodiments, the planar inductor can have a first connector and a second connector and the another planar inductor can have a third connector and a fourth connector such that the first connector or the second connector are not attached to any device attached to the third connector or the fourth connector.

In some embodiments, the first planar coil and the second planar coil are cut so that a magnetically conductive core can be used to hold multiple planar coils. An air bobbin can be used to hold two or more planar inductors in place. Connecting the combination of the first planar coil, the bridge and the second planar coil to a combination of a third planar coil, a second bridge and a fourth planar coil through the connection points can create a larger winding.

Further features and advantages of the present invention as well as the structure and operation of various embodiments of the present invention are described in detail below with reference to the accompanying drawings.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a planar coil.

FIG. 2 shows a stack of planar coils.

FIG. 3 shows a front sectional view of a stack of planar coils forming a planar inductor.

FIG. 4 shows a stack of planar coils with a magnetically conductive core.

FIG. 5 shows a pair of planar coils connected with bridge that are created from a unitary section of conductive material.

FIG. 6 shows a process for creating a planar inductor.

FIG. 7 shows an ignition transformer.

FIG. 8 shows a process for creating an ignition transformer.

### DESCRIPTION OF THE INVENTION

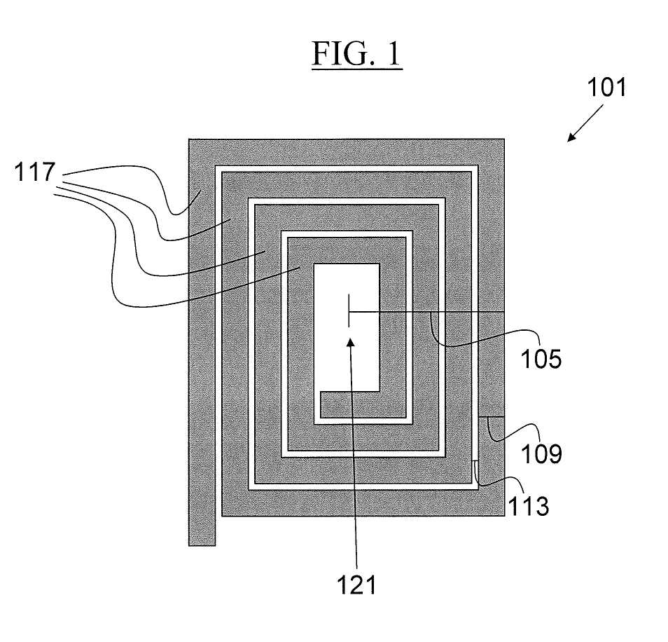

FIG. 1 shows a planar coil 101. The planar coil 101 has a coil width 105, a turn width 109, an inter-turn spacing 113, and a turn number 117. The coil width 105 is a distance from a center of the planar coil to a furthest edge of the planar coil 101. The turn width 109 is a width of a turn of the planar coil 101. The inter-turn spacing 113 is a gap between adjacent turns of the planar coil 101. The turn number 117 is the number of turns the planar coil 101 takes. At or around the center of the planar coil 101 is a hole 121. A magnetically conductive core (see below) can be inserted into the hole 121.

The planar coil 101 can be made from a conductive material, such as copper or aluminum. In some embodiments, the planar coil 101 is made solely of a conductive material. The conductive material is cut, etched, or similarly manipulated in order to achieve a desired shape and size. The conductive material can be cut, etched, or similarly manipulated to have the turn diameter 105, the turn width 109, the inter-turn spacing 113, and the turn number 117. The conductive material used for the planar coil 101 can be thermally conductive such that the surface of the planar coil 101 is thermally conductive.

In other embodiments (not shown), the planar coil 101 can be supported on a printed circuit board (“PCB”). The planar coil 101 can be prefabricated before being bonded to a PCB substrate. A sheet of the conductive material can also be bonded to a PCB substrate and subsequently cut, etched or similarly manipulated to achieve the desired shape and size on a PCB.

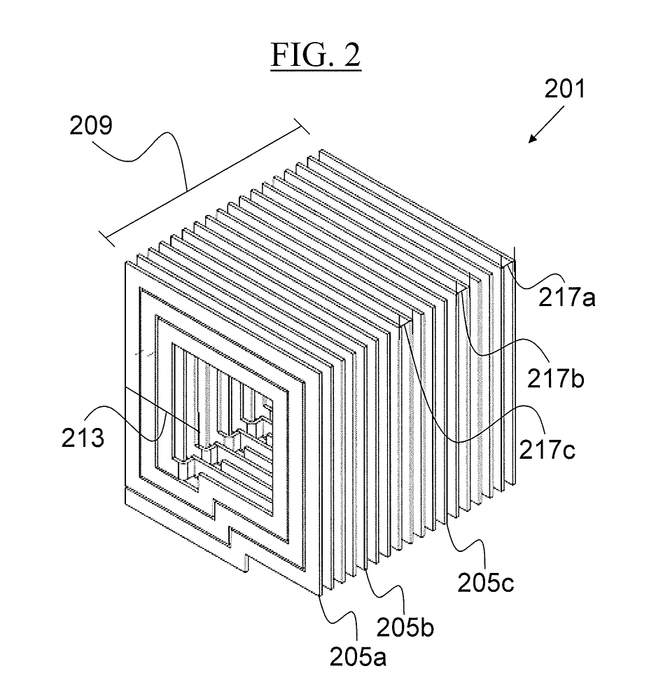

FIG. 2 shows a planar inductor made up of a stack of planar coils 201. The stack of planar coils 201 can have similar properties exhibited by a coil of wire. For example, each individual planar coil (e.g., planar coils 205a-c) can represent a single turn in a coil of wire and thus using more planar coils 205a-c can yield more inductance like having more turns in a coil with a traditional inductor. Other properties of traditional wire-coil inductors can be realized with the stack of planar coils 201. A length 209 can have similar effects to the inductance of the planar inductor as would the length of a coil of wire for a traditional inductor. A width 213 can be determined by measuring the distance from an outer edge of a planar coil 205a to the center of the planar coil 205a. Gaps are present in the stack of planar coils 201 (e.g., gap 217a-c). These gaps are used as cooling channels. A cooling channel exists between every two planar coils. A cooling fluid, such as air, can be introduced into the cooling channel in order to cool the planar coils that form the cooling channel. In some embodiments, the cooling fluid can be any type of liquid or gas.

In some embodiments, the planar coils 205a-c can be identical. In other embodiments, the planar coils 205a-c can have be different and have dissimilar shapes, sizes, thickness or compositions.

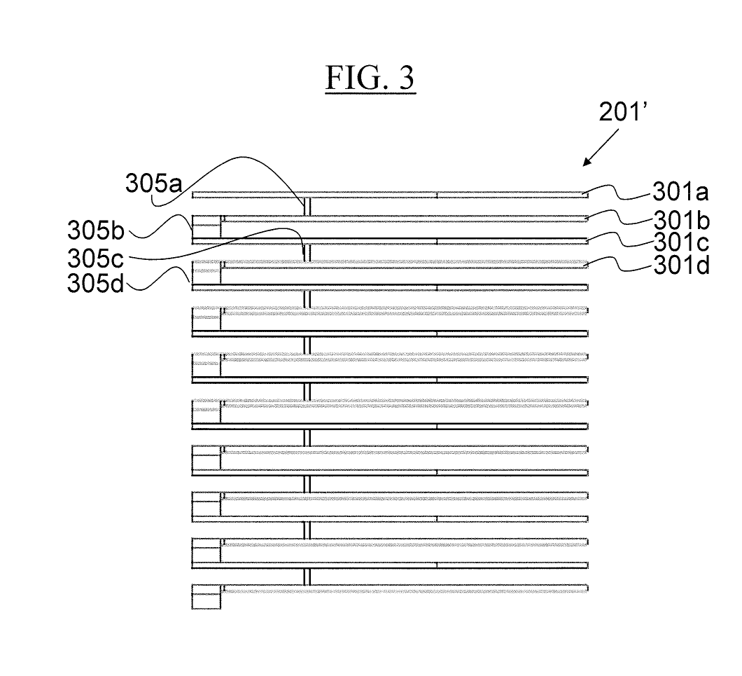

FIG. 3 shows a front sectional view of the stack of planar coils 201′. Planar coils in the stack of planar coils 201′ are all connected. For example, planar coil 301a is connected to planar coil 301b through connection point 305a, planar coil 301b is connected to planar coil 301c through connection point 305b, planar coil 301c is connected to planar coil 301d through connection point 305c, and so on. The purpose of connection points 350a-c is to make the stack of planar coils appear to be a single wire, much like traditional inductors which are made from a single wire.

In some embodiments, there can be multiple types of connection points. For example, connection point 305a can be a wire or spacer and connection 305b can be a contiguous portion of a conductive material between two planar coils (e.g., planar coil 301b and planar coil 301c). The wire or spacer can be soldered to a planar coil.

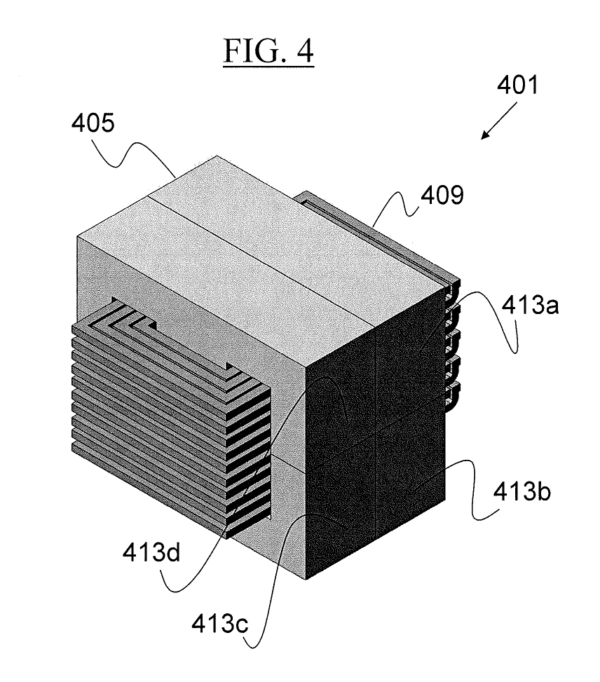

FIG. 4 shows a planar inductor 401. The planar inductor 401 includes a magnetically conductive core 405. The magnetically conductive core 405 is used to increase the inductance of the stack of planar coils 409. The magnetically conductive core 405 can be made from any magnetically conductive materials, such as iron. The magnetically conductive core 405 can be used to support or hold a stack of planar coils 409. The magnetically conductive core 405 can surround a stack of planar coils 409, as depicted in FIG. 4.

In some embodiments, the magnetically conductive core 405 can be an E-type conductive core, meaning the magnetically conductive core 405 is shaped like the capital letter “E.” As shown in FIG. 4, the magnetically conductive core 405 can be made from 4 E-type conductive cores (e.g., 413a-d). The E-type conductive cores 413a-d can be made of different types of conductive material or can be made of the same conductive material. In some embodiments, only two E-type conductive cores are used. In other embodiments, any number of E-type conductive cores can be used.

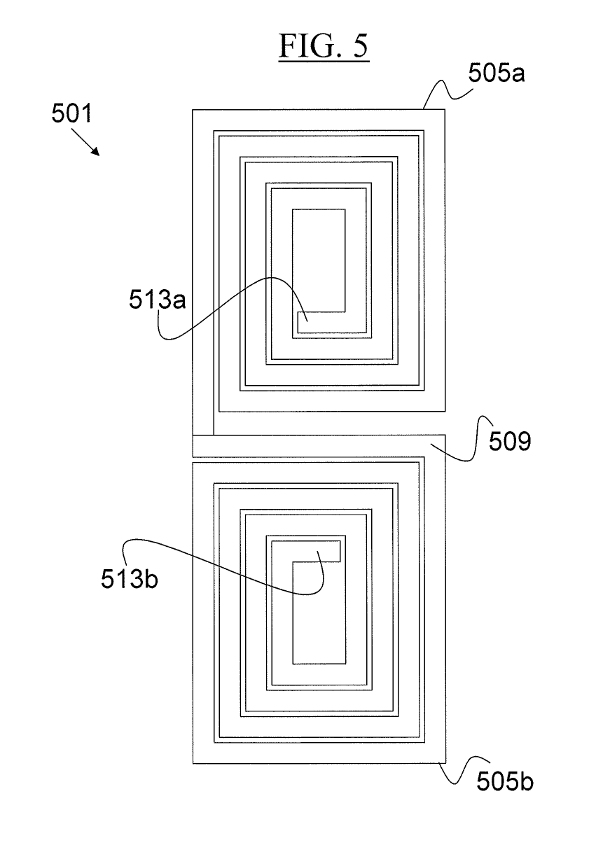

FIG. 5 shows a combined pair of planar coils 501. The combined pair of planar coils 501 includes a first planar coil 505a and a second planar coil 505b. The first planar coil 505a and the second planar coil 505b are connected through a bridge 509. The bridge 509 can act as a connection point between the first planar coil 505a and the second planar coil 505b. The combined pair of planar coils 501 can be fabricated from a unitary section of thermally and electrically conductive material. Fabrication can be done by etching, cutting (e.g., with a plasma arc torch or with a laser), milling or any other method that can manipulate the unitary section of thermally conductive material and be used to create the winding in the first planar coil 505a or the second planar coil 505b.

In some embodiments, the bridge 509 can be bent twice so that the first planar coil 505a and the second planar coil 505b are substantially parallel (e.g., the bends can be approximately 90 degree bends towards a common point). In other words, an upper surface of the first planar coil 505a is oriented toward a lower surface of the second planar coil 505b. The portion of the bridge 509 between bends can define a thickness. The thickness determines how far apart the first planar coil 505a and the second planar coil 505b are from each other. The distance between the first planar coil 505a and the second planar coil 505b can define a spaced relationship for the planar inductor. The spaced relationship can be used as a distance between pairs of planar coils in a planar inductor. End point 513a and end point 513b can also be bent so that the combined pair of planar coils 501 can be connected to other pairs of planar coils. In some embodiments, instead of bending end point 513a or end point 513b, connectors can be affixed to the end point 513a or the end point 513b.

By positioning the first planar coil 505a and the second planar coil 505b to be substantially parallel, a cooling channel is defined. A cooling fluid, such as air, can be introduced into the cooling channel in order to cool the first planar coil 505a and the second planar coil 505b. In some embodiments, the cooling fluid can be any type of liquid or gas. In embodiments where multiple pairs of planar coils are used, a cooling channel can exist between adjacent pairs of planar coils. The number of cooling channels formed can be equal to one less than twice the number of pairs of planar coils.

Manufacturing the combined pair of planar coils 501 has several advantages. First, the combined pair of planar coils 501 eliminates having to create some connection points. This is because the bridge 509 acts as a connection point. Eliminating some connection points can speed up the process of creating a planar inductor, use less materials (e.g., no need for additional wires and solder), and avoid some manufacturing defects (e.g., such as from an improperly connected wires). Second, the bridge 509 can be used to maintain a consistence gap between the first planar coil 505a and the second planar coil 505b, which is important for cooling purposes.

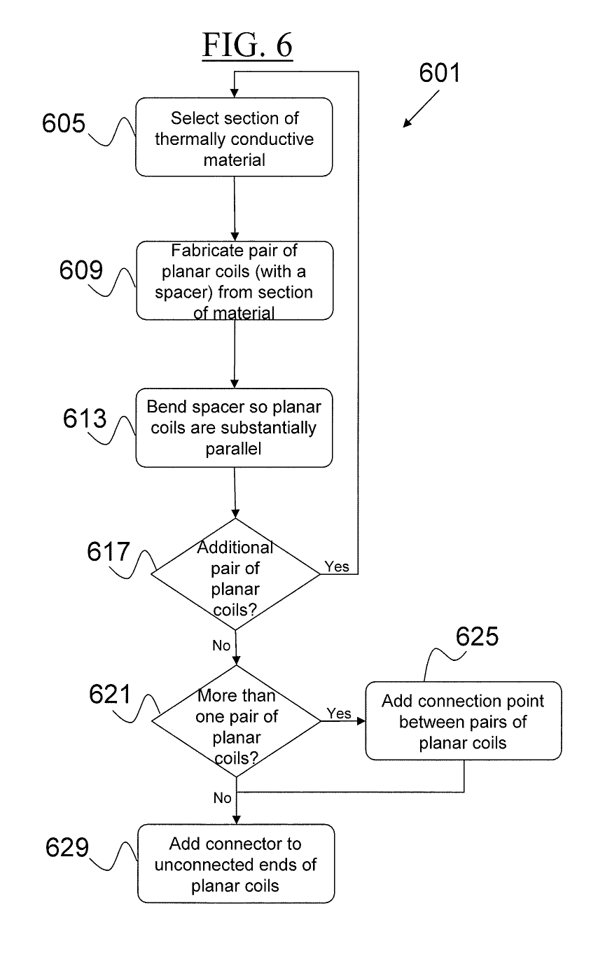

FIG. 6 shows a process 601 for creating planar inductors. In step 605, a unitary section of thermally conductive material is selected. The unitary section of thermally conductive material is the basis for a pair of planar coils. A pair of planar coils and a bridge are fabricated from the selected section of thermally conductive material in step 609. The pair of planar coils and bridge can resemble a configuration as shown in FIG. 5. As described above, fabrication can be done by cutting, etching or similarly manipulating the section of thermally conductive material. The bridge is bent in step 613. The bridge is bent at two different locations so that the pair of planar coils is substantially parallel. In step 617, if an additional planar coil is needed (e.g., another pair of planar coils is necessary to achieve a desired inductance), the process repeats itself starting at step 601. When all additional pairs of planar coils are created, connection points will be added in step 625. In some embodiments, pairs of planar coils are spaced the same as between the first planar coil and the second planar coil of a pair of planar coils. Step 625 is necessary only if there is more than one pair of planar coils, since the bridge acts as a connection point between pairs of planar coils. The decision to add connection points in step 625 is made at step 621. Connection points can be a solder joint, wire, or metal spacer with a fastener between end points of planar coils belonging to different pairs of planar coils (e.g., end point 513a or end point 513b). After all the connection points have been added, connectors, such as termination wires, are added to unconnected ends of any planar coils in step 629. In some embodiments, there are only two unconnected ends in the planar inductors. The connectors are available for connecting the inductor to the external world as per the requirements of the application.

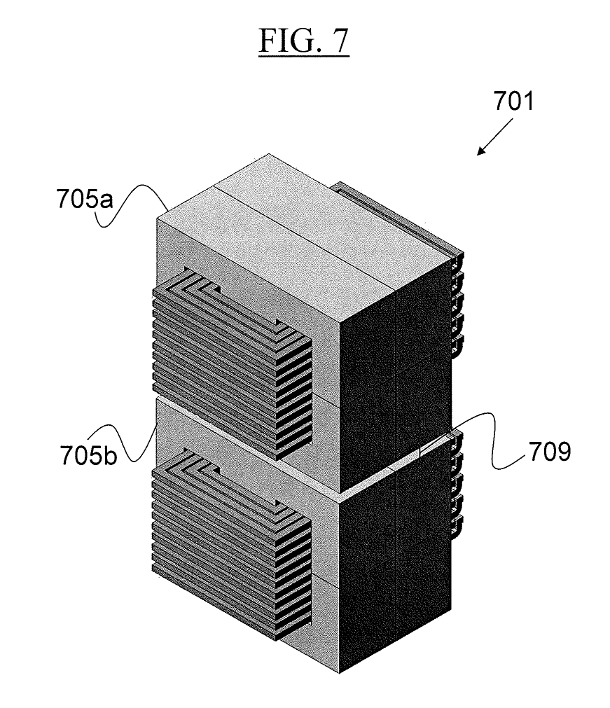

FIG. 7 shows an ignition transformer 701. The ignition transformer 701 can be made by coupling a first planar inductor 705a and a second planar inductor 705b. A fixed gap 709 is maintained between a first planar inductor 705a and a second planar inductor 705b. The inductance of the first planar inductor 705a can be determined using turn diameters, turn widths, inter-turn spacings, and turn numbers of the first planar inductor 705a. Similarly, the inductance of the second planar indictor 705b can be determined using turn diameters, turn widths, inter-turn spacings, and turn numbers of the second planar inductor 705b. The coupling factor between the two coils is determined by the respective coil inductances and the fixed gap 709. Transformers have four or more connectors (two per planar inductor) for connecting to a source or a load.

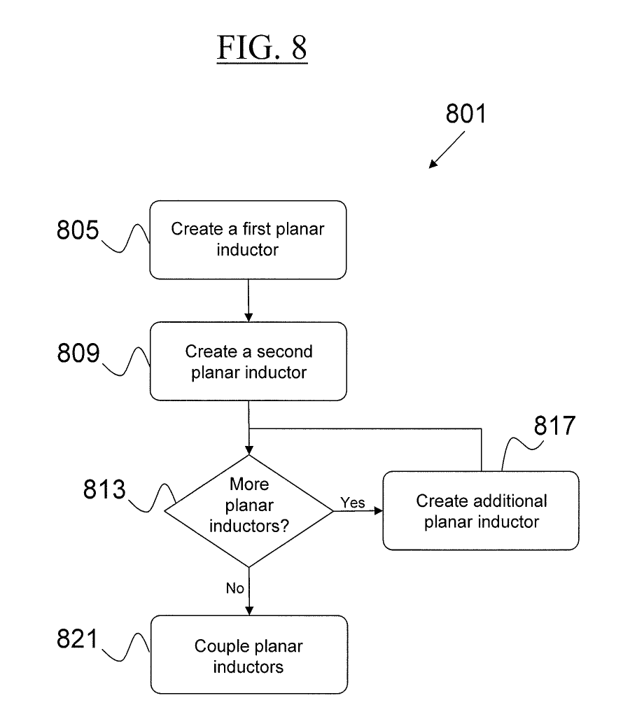

FIG. 8 shows a process 801 for creating ignition transformers. In step 805, a first planar inductor is created. In some embodiments, step 805 is or is similar to process 601. In step 809, a second planar inductor is created. In some embodiments, step 809 is or is similar to process 601. A decision to make more planar inductors is made in step 813. If more planar inductors are necessary, step 817 creates additional planar inductors. In some embodiments, step 817 is or is similar to process 601. Step 813 is repeated as many times as needed (e.g., to create as many planar inductors as needed). The planar inductors created are coupled in step 821. Coupling can be simply placing two or more planar inductors in close proximity to each other, such as by stacking them with an air gap in-between each planar inductor. Coupling can also be done using insulated stand-offs or spacers of a required height. Bobbins can also be used in a transformer. Bobbins can be selected for the affect on the inductance of the transformer or for achieving a desired distance between inductors. The spacing between inductors can also be used to form additional cooling channels to help cool the transformer (thereby meaning there are cooling channels between planar coils and between inductors).

In some embodiments, cooling fans are used to direct air flow in between cooling channels to cool both planar inductors and ignition transformers. However, any type of fluid cooling can be used to cool inductors or transformers. In some embodiments, multiple types of fluid cooling can be used.

While the invention has been particularly shown and described with reference to specific preferred embodiments, it should be understood by those skilled in the art that various changes in form and detail can be made therein without departing from the spirit and scope of the invention as defined by the appended claims. The alternatives described herein are examples for illustration only and not to limit the alternatives in any way. The steps of the invention can be performed in a different order and still achieve desirable results. Other embodiments are within the scope of the following claims.

What is claimed is:

1. A planar inductor comprising:
a magnetically conductive core;
a first planar coil, attached to a first bridge, located about the core, composed of conductive material and having at least one thermally conductive surface exposed to cooling fluid;
a second planar coil, attached to the first bridge, located about the core, composed of conductive material and having at least one thermally conductive surface exposed to cooling fluid;
wherein the first planar coil, the first bridge and the second planar coil are formed from a first unitary section of conductive material; and
the second planar coil is positioned relative to the first planar coil in a spaced relationship, which is defined by a thickness of the first bridge such that an upper surface of the first planar coil is oriented toward a lower surface of the second planar coil to define a first cooling channel between the first planar coil and the second planar coil.

2. The planar inductor of claim 2, further comprising:
a third planar coil, attached to a second bridge, located about the core, composed of the conductive material and having at least one thermally conductive surface exposed to cooling fluid;
a fourth planar coil, attached to the second bridge, located about the core, composed of conductive material and having at least one thermally conductive surface exposed to cooling fluid;
wherein the third planar coil, the second bridge and the fourth planar coil are formed from a second unitary section of conductive material;
the third planar coil is positioned relative to the second planar coil in a spaced relationship equal to the thickness of a bent portion of the first bridge or the thickness of a bent portion of the second bridge such that an upper surface of the second coil is oriented toward a lower surface of the third coil to define a second cooling channel between second planar coil and the third planar coil; and
the fourth planar coil is positioned relative to the third planar coil in a spaced relationship defined by a thickness of a bent portion of the second bridge such that an upper surface of the third coil is oriented toward a lower surface of the fourth coil to define a third cooling channel between third planar coil and the fourth planar coil.

3. The planar inductor of claim 2, wherein n pairs of planar coils can be added to form 2n−1 cooling channels.

4. The planar inductor of claim 3, wherein a first pair of planar coils is positioned in a spaced relationship relative to a second part of planar coils, the spaced relationship equal to a thickness of a bent portion of the first pair bridge or a thickness of a bent portion of the second pair bridge.

5. The planar inductor of claim 1, wherein planar coils can be stacked to achieve a desired inductance value.

6. The planar inductor of claim 1, wherein fluid cooling is done using a fan that is oriented to direct an air flow to cool the planar inductor through the first cooling channel, below the first planar coil and above the second planar coil.

7. The planar inductor of claim 2, wherein the thickness of the bent portion of the first bridge and the thickness of the bent portion of the second bridge is the same.

8. The planar inductor of claim 2, wherein the first unitary section of conductive material and the second unitary section of conductive material are identical.

9. The planar inductor of claim 1, wherein the conductive material is cooper or aluminum.

10. The planar inductor of claim 1, wherein the magnetically conductive core is an E-type core.

11. The planar inductor of claim 2, wherein the second planar coil and the third planar coil are soldered together so that the first planar coil, the second planar coil, the third planar coil and the fourth planar coil are connected through the first bridge, a solder joint, and the second bridge.

12. The planar inductor of claim 2, further comprising a first connector and a second connector for allowing the planar inductor to be connected to a voltage source or a load.

13. An ignition transformer comprising:
the planar inductor of claim 1 coupled to a second planar inductor of claim 1;
wherein the planar inductor and the second planar inductor are separated by a fixed gap to provided a predetermined inductance value for the ignition transformer.

14. The ignition transformer of claim 13, wherein the fixed gap is maintained using standoffs or spacers of a required height bobbin.

15. The ignition transformer of claim 13, wherein the planar inductor has a first connector and a second connector and the another planar inductor has a third connector and a fourth connector such that:
the first connector or the second connector are not attached to any device attached to the third connector or the fourth connector.

16. A method of manufacturing a planar inductor, the method comprising:
cutting a section of thermally conductive material into a pattern to create a first planar coil, a second planar coil and a bridge disposed between such first and second planar coils;
bending the section of thermally conductive material at the bridge such that the second planar coil is positioned opposite and at least substantially in parallel to the first planar coil; and
creating at least two connection points for a combination of the first planar coil, the bridge and the second planar coil.

17. The method of claim 16, wherein the first planar coil and the second planar coil are cut so that a magnetically conductive core can be used to hold multiple planar coils.

18. The method of claim 16, further comprising connecting the combination of the first planar coil, the bridge and the second planar coil to a combination of a third planar coil, a second bridge and a fourth planar coil through the connection points to create a larger winding.

19. A method of manufacturing an ignition transformer, the method comprising:
selecting two or more planar inductors that are created by:
cutting a section of thermally conductive material into a pattern to create a first planar coil, a second planar coil and a bridge disposed between such first and second planar coils;
bending the section of thermally conductive material at the bridge such that the second planar coil is positioned opposite and at least substantially in parallel to the first planar coil; and
creating at least two connection points for a combination of the first planar coil, the bridge and the second planar coil; and
coupling the two or more planar inductors by placing the two or more planar inductors in a close proximity such that there is a fixed gap between the two or more planar inductors.

20. The method of claim 19 wherein coupling further comprising using an air bobbin to hold the two or more planar inductors in place.

21. A method of using planar coils to form a planar inductor comprising:
utilizing a magnetically conductive core;
utilizing a first planar coil, attached to a first bridge, located about the core, composed of conductive material and having at least one thermally conductive surface exposed to cooling fluid;
utilizing a second planar coil, attached to the first bridge, located about the core, composed of conductive material and having at least one thermally conductive surface exposed to cooling fluid;
wherein the first planar coil, the bridge and the second planar coil are formed from a first unitary section of conductive material; and
the second planar coil is positioned relative to the first planar coil in a spaced relationship defined by a thickness of a bent portion of the first bridge such that an upper surface of the first planar coil is oriented toward a lower surface of the second planar coil to define a first cooling channel between first planar coil and the second planar coil.

22. A combination heat exchanger inductor comprising:
a magnetically conductive core;
a substantially rigid, first planar coil located about the core, composed of conductive material and having a first exposed thermally conductive surface;
a substantially rigid, second planar coil located about the core, composed of said conductive material and having a second thermally conductive surface;
a substantially rigid bridge contiguous with said first and second planar coils and composed of said conductive material, the bridge being oriented at least substantially orthogonal to said first and second planar coils (i) to provide a spaced relationship and define a cooling channel, and (ii) to orient said first and second thermally conductive surfaces opposite each other with said cooling channel therebetween.

23. A method of manufacturing an inductor comprising:
providing a magnetically conductive core;
etching a conductive material to form a substantially rigid, first planar coil having a first exposed thermally conductive surface and a second planar coil having a second thermally conductive surface;
manipulating said conductive material to form a substantially rigid bridge contiguous with said first and second planar coils, the bridge being oriented at least substantially orthogonal to said first and second planar coils (i) to provide a spaced relationship and define a cooling channel, and (ii) to orient said first and second thermally conductive surfaces opposite each other with said cooling channel therebetween.
